(19) United States
(12) Patent Application Publication
(10) Pub. No.: US 2009/0107301 A1
(43) Pub. Date: Apr. 30, 2009

(54) WRENCH WITH SLIM PROFILE

(76) Inventor: J. EWING LAMBERT, INDIANOLA, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/877,957

(22) Filed: Oct. 24, 2007

(51) Int. Cl. B25B 13/06

(52) U.S. Cl. 81/121.1

(57) ABSTRACT

A slim profile wrench is provided for reaching nuts and bolts in tight spaces. The wrench includes first and second casing members which encloses a chain trained about sprockets at opposite ends of the wrench. Each sprocket includes an integral female drive and an integral female socket on opposite ends. Rotation of a drive shaft inserted into the female drive rotates the female socket at the opposite end via the chain. The casing members are secured together by fasteners extending into a central wall within the casing members. The wall also defines spaced apart channels which provide a guide track for the chain. Wear bushings are provided on each side of each sprocket.

### FIELD OF THE INVENTION

The present invention is directed towards a wrench having a slim profile for tightening and loosening nuts and bolts in tight spaces or otherwise having limited access.

### BACKGROUND OF THE INVENTION

Wrenches of various sizes and shapes are commonly used for tightening and loosening nuts and bolts. One common type of wrench is a socket wrench including a socket rotated in clockwise and counterclockwise directions by a drive lever or arm. The socket typically includes a square hole on one end to matingly receive the square male drive shaft, and a hexagon or multifaceted opening on the other end for receipt of the nut or bolt head.

Specialty flat or slim profile wrenches are also known for reaching nuts and bolts in tight spaces. Both gear drive and chain drive flat wrenches are known from the prior art. The gear drive wrenches include a plurality of intermeshing gears, which increases the manufacturing cost due to the number of pieces in the wrench. Chain drive flat wrenches generally are light weight and do not allow substantial torque to be applied to the nut or bolt head.

Therefore, a primary objective of the present invention is the provision of an improved slim profile wrench for reaching nuts and bolts in tight spaces.

Another objective of the present invention is the provision of a flat wrench having a heavy duty chain drive.

Another objective of the present invention is the provision of a tight reach wrench having a one piece female drive, female socket, and sprocket.

Another objective of the present invention is the provision of a slim profile wrench which can be coupled with other similar wrenches in an end-to-end series through male to male couplers.

Another objective of the present invention is the provision of a flat wrench having an internal channel or track for guiding the drive chain.

Still another objective of the present invention is the provision of a flat wrench having flush sockets and drives.

Yet another objective of the present invention is the provision of a flat wrench having wear bushings on the sockets and drives at end of the wrench.

Another objective of the present invention is the provision of a flat, slim profile wrench for use in tight spaces which is economical to manufacture, and durable in use.

These and other objectives will become apparent from the following description of the invention.

### BRIEF SUMMARY OF THE INVENTION

A slim profile wrench is provided for reaching nuts and bolts in tight spaces. The wrench includes first and second rigid casing members each having opposite ends. An internal wall in at least one casing member defines longitudinally extending channels or tracks for a drive chain. The casing members are secured together by fasteners extending into the central channel wall. Rotatable sprockets are provided at each end of the wrench. Each sprocket has a female drive on one side and a female socket on the other side. Each end of each casing member includes a recess for receiving a wear bushing residing on each side of each sprocket. The sprocket, female drive, and female socket are formed as one piece. The drive and socket are flush with the casing members so that the wrench has flat upper and lower surfaces. The drive chain extends around the sprockets and along the channels to transfer rotational drive from one end of the wrench to the other end. Multiple wrenches can be provided with different sized sockets, and can be connected in an end-to-end series through the use of an adapter or coupler having opposite male ends.

### BRIEF DESCRIPTION OF THE DRAWINGS

FIG. 1 is a perspective view of the wrench of the present invention, with a standard socket wrench mounted on one end.

FIG. 2 is another perspective view of the wrench of the present invention with a conventional drive wrench on one end and an adapter and socket on the other end.

FIG. 3 is an exploded view of the components of the wrench of the present invention in a disassembled state.

FIG. 4 is an exploded perspective view of the wrench in a partially assembled state.

FIG. 5 is a perspective view of the sprocket from the socket end.

FIG. 6 is a perspective view of the sprocket from the drive end.

FIG. 7 is a perspective view of the adapter with opposite male ends.

### DETAILED DESCRIPTION OF THE DRAWINGS

The wrench of the present invention is generally designated in the drawings by the reference numeral 10. The wrench 10 has a slim profile for use in tightening and loosening nut and/or bolts in tight spaces having minimal clearance. The upper and lower outer surfaces of the wrench 10 are flat, for ease of insertion into a small space without interference.

The wrench 10 includes first and second casing members 12, 14, which in a preferred embodiment, are identical to one another. The casing members 12, 14 are preferably cast metal. The wrench 10 also includes sprockets 16 at the opposite ends, with an internal chain 18 trained about the sprockets 16 to rotate the sprockets in clockwise and counterclockwise directions, as described below. Each sprocket 16 includes a female drive 20 on one end and a female socket 22 on the opposite ends. Preferably, the sprocket 16, drive 20 and socket 22 are integrally formed as a one piece unit 23 for strength and ease of assembly of the wrench 10.

Each casing member 12, 14 has an internal wall 24 extending longitudinally, so as to define channels or tracks 26 on opposite sides of the wall 24. The channels 26 provide a track for the chain 18, while the wall 24 precludes the chain 18 from rubbing against itself between the ends of the wrench 10. In an alternative embodiment, the wall 24 can be formed on one casing member, while the other casing member has a flat inside surface to abut the wall when the members 12, 14 are assembled.

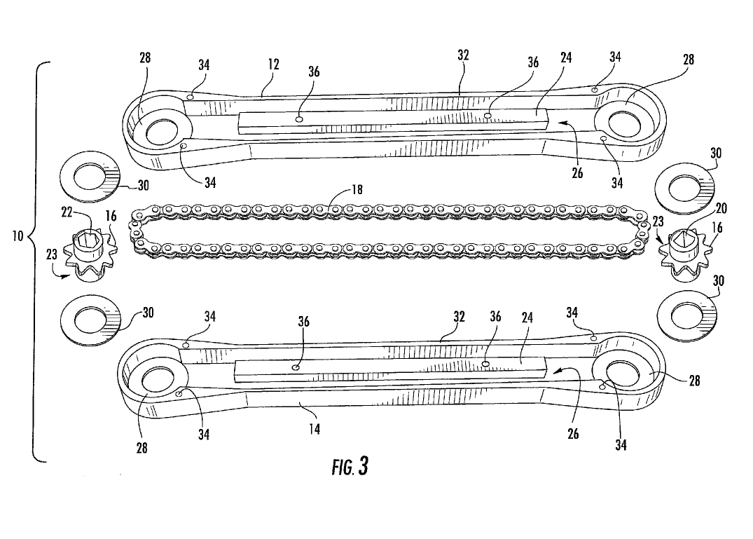

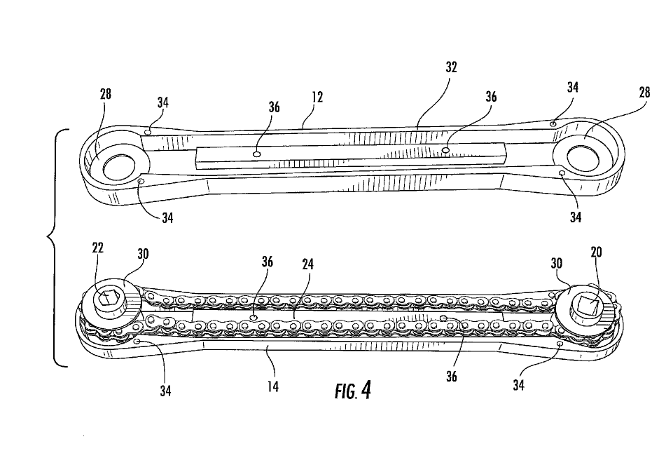

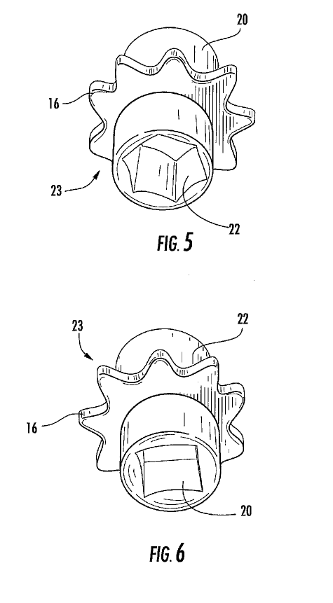

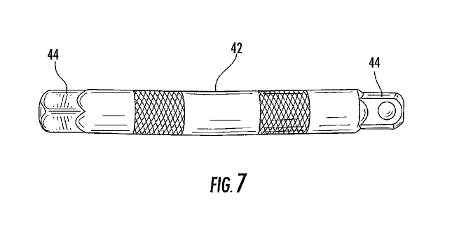

Each casing member 12, 14 also includes a circular recess 28 on the inside surface at each end to receive a wear bushing 30, as best seen in FIG. 3. The wear bushing 30 is in the form of a washer with a central opening through which the drive 20 or socket 22 extends. The bushings 30 overlie the chain 18, as seen in FIG. 4.

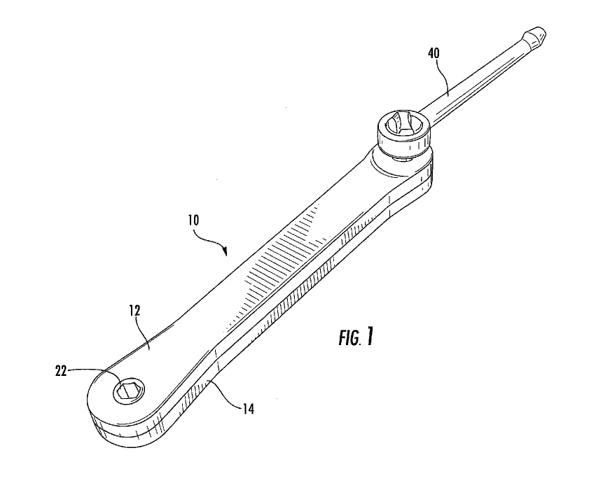

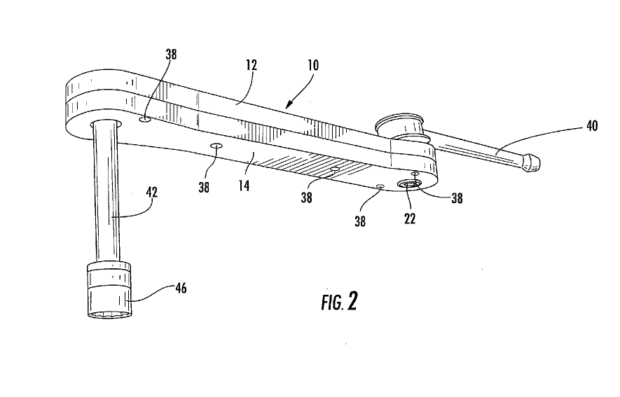

Each casing member 12, 14 includes a perimeter lip 32. The lips 32 and the walls 24 of the casing members 12, 14 include holes 34, 36, respectively for receiving threaded fasteners 38. The holes 34, 36 on one of the casing members 12, 14 are threaded, while the holes 34, 36 on the other of the casing members 12, 14 are not threaded, such that the fasteners 38 extend through the unthreaded holes 34, 36 for threaded receipt in the threaded holes 34, 36. As seen in FIGS. 1 and 2, when the casing members 12, 14 are assembled, the perimeter lips 32 engage one another so as to enclose the chain 18.

The female drive 20 of each sprocket 16 preferably is in the form of a square hole to matingly receive a square drive shaft on a conventional socket wrench 40. The female socket 22 of each sprocket 16 preferably has a hexagon opening or a multi faceted opening adapted to fit over the head of a bolt or onto a nut. Thus, when the socket wrench 40 is actuated to rotate the female drive 20 at one end of the wrench 10, the socket 22 at the other end of the wrench is rotatably driven by the chain 18 so as to tighten or loosen the nut and bolt assembly.

Preferably, the drives 20 of each end of the wrench 10 are oriented on opposite top and bottom surfaces of the wrench 10, with the female sockets 22 similarly being on opposite top and bottom surfaces of the wrench 10. The female sockets 22 preferably are different sizes at each end of the wrench 10, but may be the same size. Thus, either end of the wrench 10 can be used as the drive end and the socket end.

A set of wrenches 10 can be provided each having different sized female sockets 22, in English and/or metric versions. Therefore, the sprocket, drive, socket unit 23 does not have to be interchanged within one wrench 10 so as to accommodate different sized nuts or bolts. Thus, each wrench 10 is an integral unit, and the set of wrenches eliminates the need to disassemble the wrench 10 to substitute different sized sockets in a single wrench housing, as in the prior art.

Multiple wrenches 10 can also be used in an end-to-end series for an extended reach. For such an end-to-end series, an adapter 42 is provided which has a square male head 44 on each end for receipt in the female drive 20 of the respective wrenches 10 opposite the wrench 40. The adapter 42 can also be used with a single wrench 10 and an auxiliary socket 46 on the outer head 44 of the adapter 42, as seen in FIG. 2. Adapters 42 with different lengths may be provided. The auxiliary socket 46 may be any conventional socket with a female recess to receive the head 44 on the end of the adapter 42.

The chain tracks 26 and the integral, one piece construction of the sprocket, socket and drive unit 23 allows the wrench 10 to apply high torque. Also, pneumatic drives can be applied to the wrench 10.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

1. A wrench, comprising:
first and second rigid casing members each having opposite ends;
a wall in the first casing member defining opposite channels extending longitudinally;
fasteners extending through the second casing member and into the wall to secure the first and second casing members together;
first and second sprockets rotatably mounted between the casing member at each of the ends;
each sprocket having opposite sides, with a square female drive on one side and a hexagon female socket on the other side;
a chain extending around the sprockets and along the channels so as to transfer rotational drive at one end to the socket at the other end so as to tighten and loosen nuts and bolts; and
the sprocket, female drive and female socket are formed as one piece.

2. The wrench of claim 1 wherein the sockets on the first and second sprockets are different sizes.

3. The wrench of claim 1 wherein the casing members are identical.

4. The wrench of claim 1 further comprising a second wall in the second casing member to define opposite channels extending longitudinally.

5. The wrench of claim 1 further comprising a flat wear bushing on the opposite sides of the chain at each end of the sprocket.

6. The wrench of claim 5 further comprising a recess in each end of each casing member to receive one of the wear bushings.

7. (canceled)

8. The wrench of claim 1 further comprising an adapter having opposite male ends to connect one of the sprockets to a separate socket.

9. The wrench of claim 8 wherein the separate socket is on a second wrench having the same casing member, wall and chain structures so that the wrenches are connected in series end-to-end.

10. The wrench of claim 1 wherein the casing members have a flat profile along their full length and the female drives and sockets reside within the casing members.

11. A wrench comprising:
first and second casing members each having opposite ends;
first and second sprockets rotatably mounted between the casing member at each of the ends;
each sprocket having opposite sides, with a square female drive on one side and a hexagon female socket on the other side;
a chain extending around the sprockets and along the channels so as to transfer rotational drive from one end of the wench to the socket at the other end of the wrench, and having opposite sides;
a recess formed in each end of the casing members; and
a fiat wear bushing on each side of the chain at each end of the sprocket and being received in one of the recesses.

12. The wrench of claim 11 wherein the sockets are different sizes.

13. The wrench of claim 11 wherein the casing members are identical.

14. The wrench of claim 11 further comprising opposite channels extending longitudinally within the casing members for guiding the chain.

15. The wrench of claim 14 further comprising a central wall within the casing members to define the channels, and fasteners extending through one of the casing members and into the wall to secure the first and second casing members together.

16. The wrench of claim 11 wherein the sprocket, female drive and female socket are formed as one piece.

17. The wrench of claim 11 further comprising an adapter having opposite male ends to connect one of the sprockets to a separate socket.

18. The wrench of claim 17 wherein the separate socket is on a second wrench having the same casing member, wall and chain structures so that the wrenches are connected in series end-to-end.

19. The wrench of claim 11 wherein the casing members have a flat profile along their full length and the female drives and sockets reside within the casing members.

20. The wrench of claim 11 wherein the casing members have flat outer sides and the female drives and female sockets are substantially flush with the sides of the casing members.
